(19) United States
(12) Patent Application Publication
(10) Pub. No.: US 2015/0199483 A1
(43) Pub. Date: Jul. 16, 2015

(54) SETTLEMENT OF PATIENT RESPONSIBILITY FOR HEALTH CARE SERVICE

(71) Applicant: FusionLoop LLC, Sands Point, NY (US)

(72) Inventors: Adam FRISCH, Sands Point, NY (US); Scott BRUCE, Saratoga Springs, NY (US)

(73) Assignee: FUSIONLOOP LLC, Sands Point, NY (US)

(21) Appl. No.: 14/595,617

(22) Filed: Jan. 13, 2015

Related U.S. Application Data
(60) Provisional application No. 61/926,548, filed on Jan. 13, 2014.

(51) Int. Cl. G06F 19/00

(52) U.S. Cl. CPC G06F 19/328

(57) ABSTRACT

Settlement of patient responsibility for health care service at a time and point of treatment is facilitated. Health care benefits data is obtained from a system of a payor of health care services. The data includes information indicative of an extent to which financial coverage or benefit obligations have been met for the patient under an arrangement between the patient and the payor. Based on an indication by a provider system that a determination of patient responsibility for the health care service is desired, patient responsibility for the health care service is determined based on the obtained health care benefits data. An indication of the determined patient responsibility is provided to the provider system, in order to facilitate settlement of the patient responsibility at the time and point of treatment.

### BACKGROUND

In the health care industry, providers who render health care services to a patient with health insurance or other form of health care coverage typically bill the payor(s) for the services rendered and bill any unsatisfied or uncovered amounts (referred to herein as “patient responsibility”) to the patient. Depending on factors such as the health care coverage amounts and other plan details of the patient's health care plan, as well as the degree to which coverages, such as a plan deductible, have been satisfied, the patient may have a varying extent of patient responsibility. Problems can exist for providers when attempting to collect money, that is the patient's responsibility, either prior to or after the payor(s) have satisfied their obligations for reimbursing the providers.

### BRIEF SUMMARY

Shortcomings of the prior art are overcome and additional advantages are provided through the provision of a method to facilitate settlement of patient responsibility for health care service at a time and point of treatment, the method including: obtaining, from a system of a payor of health care services, health care benefits data including information indicative of an extent to which financial coverage or benefit obligations have been met for the patient under an arrangement between the patient and the payor; based on an indication by a provider system that a determination of patient responsibility for the health care service is desired, determining patient responsibility for the health care service based on the obtained health care benefits data; and providing an indication of the determined patient responsibility to the provider system to facilitate settlement of the patient responsibility at the time and point of treatment.

Further, a system is provided to facilitate settlement of patient responsibility for health care service at a time and point of treatment, the system including: a memory; and a processor in communication with the memory, wherein the system is configured to perform: obtaining, from a system of a payor of health care services, health care benefits data including information indicative of an extent to which financial coverage or benefit obligations have been met for the patient under an arrangement between the patient and the payor; based on an indication by a provider system that a determination of patient responsibility for the health care service is desired, determining patient responsibility for the health care service based on the obtained health care benefits data; and providing an indication of the determined patient responsibility to the provider system to facilitate settlement of the patient responsibility at the time and point of treatment.

Yet further, a method is provided that includes obtaining, from a system of a payor of health care services, health care benefits data including information indicative of an extent to which financial coverage or benefit obligations have been met for a patient under an arrangement between the patient and the payor, wherein the information indicative of the extent to which financial coverage or benefit obligations have been met for the patient indicates a current extent to which one or more coverage deductibles or limits have been met for the patient for care provided to the patient; receiving, from the patient, an identification of health care service and a request for a determination of patient responsibility should the identified health care service be rendered by the patient; based on the received identification of health care service and request for the determination, determining patient responsibility for the health care service based on the obtained health care benefits data, wherein the determining the patient responsibility accounts for the current extent to which the one or more coverage deductibles or limits have been met for the patient, and wherein the patient responsibility includes a monetary amount dynamically dependent on the extent to which financial coverage or benefit obligations have been met for the patient up to the time of treatment; and providing an indication of the determined patient responsibility to the patient.

Additional features and advantages are realized through the concepts and aspects described herein. Other embodiments and aspects of the invention are described in detail herein and are considered a part of the claimed invention.

### BRIEF DESCRIPTION OF THE DRAWINGS

Aspects described herein are particularly pointed out and distinctly claimed as examples in the claims at the conclusion of the specification. The foregoing and other objects, features, and advantages of aspects of the invention are apparent from the following detailed description taken in conjunction with the accompanying drawings in which:

FIG. 1A depicts an example environment to incorporate facilities for settlement of patient responsibility for health care service, in accordance with aspects described herein;

FIG. 1B depicts another example environment to incorporate facilities for settlement of patient responsibility for health care service, in accordance with aspects described herein;

FIG. 2 depicts an example process to facilitate settlement of patient responsibility for rendered health care service at a time and point of treatment, in accordance with aspects described herein;

FIG. 3 depicts one example embodiment of a computer system to incorporate aspects described herein; and

FIG. 4 depicts one embodiment of a computer program product to incorporate aspects described herein.

### DETAILED DESCRIPTION

In a typical scenario, health care services are rendered to a patient and the patient pays, if required, a co-payment at the time and point of treatment. Then, the provider bills the service to the health insurance company, which may or may not offer some amount of reimbursement to the provider. When any residual patient responsibility, determined after claim adjudication, is billed to the patient by the provider, this occurs well after the time and point of treatment. As a result, many providers find themselves carrying patient debts, which may eventually turn to bad debts that are wholly or partially unrecoverable without significant and costly collection efforts.

Described herein are aspects to facilitate settlement of patient responsibility for health care service at a time and point of treatment. This may be facilitated through the provision of a system and portal that provides real-time indications of consumer/patient financial responsibility, such as health care benefits data related to payor health care coverage. Example health care benefits data affecting patient responsibility includes financial coverage or benefit obligations, such as policy coverage information for a patient's particular health care plan, the extent to which coverage deductible(s) and plan limits have been met for the patient (e.g. either accrued and/or paid or satisfied) to date, co-pay and co-insurance amounts for various health care services, and/or payor reimbursement levels for particular services as they relate to health care services rendered to the patient. A payor in the health care industry is an entity that pays some or all of the costs associated with covered health care services on behalf of a patient or other consumer of the services. In a typical situation, the payor is a health insurance provider or health maintenance organization, though other payor types are possible.

The data from the portal may be made readily available to health care providers and may be updated in real-time as health care services are rendered and/or resolution of claims is made. More generally, the data may include any information that enables the portal to determine and convey indications of patient responsibility, such as an amount of money a customer, e.g. patient, will ultimately be responsible for in connection with health care services rendered, or proposed to be rendered, to the patient. This can involve patient out-of-pocket amount and amount covered by insurance for a specific service, as an example.

The portal may be linked (either directly or indirectly via clearinghouses or comparable intermediary) via application programming interfaces, for instance, to health care payor facilities, such as databases and/or software platforms, that hold up-to-date information that is indicative of patient responsibility. This may include, as examples, coverage limits, data about payment(s) made by the patient and/or payors, and the amount of deductible that has been satisfied by the patient. Additionally or alternatively, software can be provided for patient devices, such as mobile devices, that enables the patient to track and record health care benefits data and use that to perform a determination of patient responsibility based on that tracked/recorded data.

The up-to-date information may be updated immediately as such payments (made by the patient or payors) are applied, and the updated information may be made immediately available to/through the portal. Furthermore, the information may be updated as requests for health care coverage data are received from the portal and/or providers. For instance, if a provider indicates to the portal that health care service will be, or was, rendered and requests a determination of patient responsibility from, e.g. the portal, the portal can provide this information to the payor system(s). The payor systems can treat that indication like it would any claim received from the provider, and therefore the payor system(s) can factor that into any health care benefits data it subsequently provides about this patient, for instance to the same or another provider.

A provider may reach out to (e.g. communicate with, for instance across a network and through web-based systems) the portal to obtain an indication of patient responsibility based on the information maintained at, e.g., the portal, relevant to the provider's reimbursement for health care service that has been or will be provided. As an example, the provider provides an indication of health care service rendered, or to be rendered, and the portal obtains from the appropriate payor system(s) information (e.g. plan information, co-pay/coinsurance/deductible amounts, and so forth) that the portal can use to make an accurate and up-to-date determination of patient responsibility for such service. The portal may provide an indication of patient responsibility back to the provider. The indication of patient responsibility may include money due to the provider, such as an amount due out of customer pocket, or any other patient obligations. Some or all of this may occur during patient check-in or check-out at the provider for a visit at which some or all of the subject health care service is rendered to the patient. In this regard, a patient who has just been rendered health care service may engage in a check-out session at which it is determined, in real-time, all monies that the customer may owe for such services, and this can include not only co-pay amounts but also any amount that is, or will become, due from the customer after the payor fully adjudicates these claims. It is apparent that patient responsibility for a given service is in large part a dynamic number that depends on the extent to which the patient has used or consumed deductibles, coverage limits, or other financial coverage or benefit obligations during the plan term up to that point of treatment. For instance, if the patient has already satisfied his/her deductible requirement for the plan term based on prior-rendered services, that patient's financial responsibility for a next visit may be different than if the patient has satisfied only half of the deductible requirement.

In some examples, patient responsibility is determined in real-time but without the claim having been fully adjudicated by the payor. In other examples, the indication of services may be provided by the portal or other system to a payor system as a claim that may be adjudicated on the payor's end in real-time, or near real-time. An indication of patient responsibility, or the data to make such a determination, may then be provided from the payor system to the portal, and an indication of patient responsibility may then be passed on to the provider.

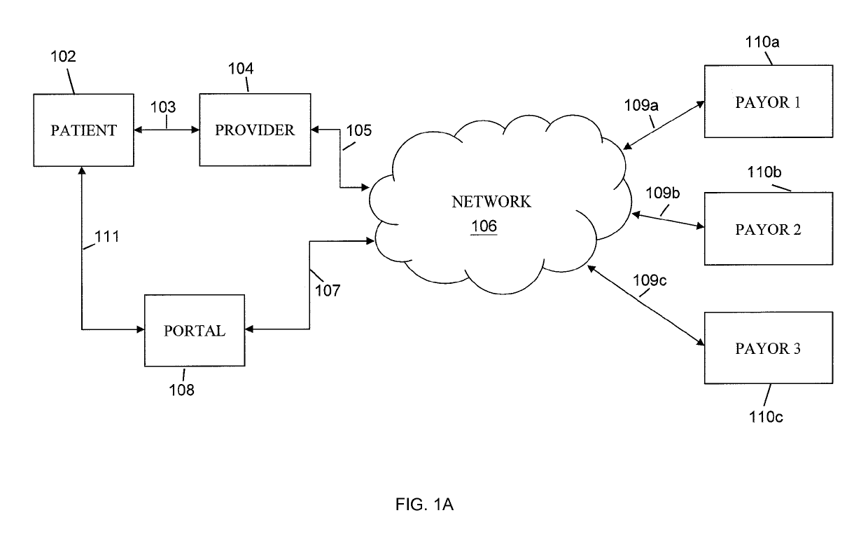

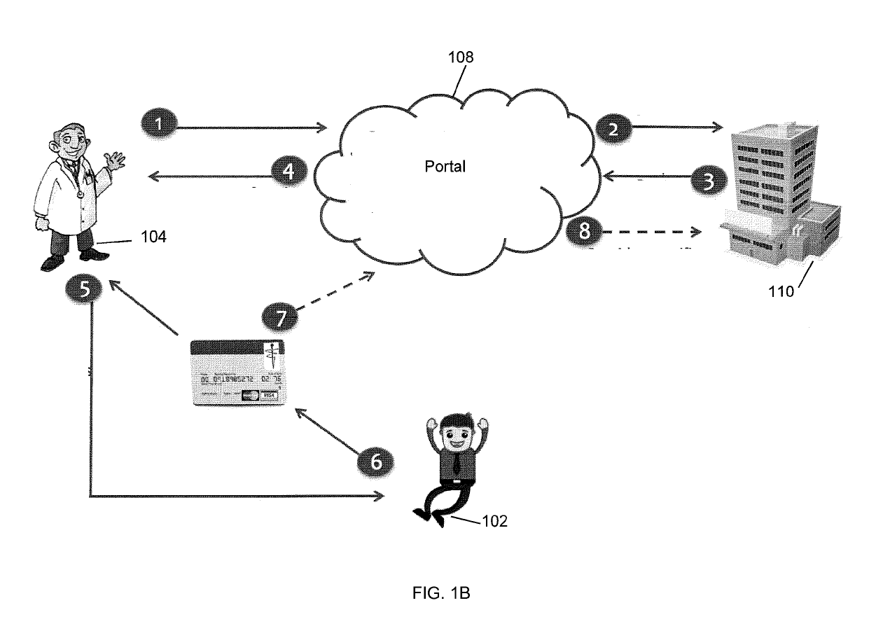

FIG. 1A depicts an example environment to incorporate facilities for settlement of patient responsibility for health care service. Though entities such as Patient, Provider, and Payor in FIG. 1A represent those players in the health services market, it should be understood that they may actually correspond to the computer systems used by those players to settle claims for health care services. Therefore, communication 103 between patient 102 and provider 104, for instance, may represent data communication between a patient system (e.g. a website, smartphone or other mobile device) 102 and a provider system 104, for instance a provider billing or office management computer system. It is noted that computerized systems play an integral role in claims presentation, adjudication, and settlement among the players in the health care services industry, and aspects described herein offer improvements in such systems.

Referring to FIG. 1, a patient 102 may interact with a provider 104 to provide identifying information about the patient. The information may include health insurance identification information, for instance the name of the health care provider, unique patient number, and so on. The provider 104 may be in communication with a portal/computer system 108 via a network 106 and data communications paths 105 and 107. The provider system 104 and/or portal 108 may be in communication with payor systems 110a, 110b, and 110c via network 106 and data communications paths 109a, 109b, and 109c, respectively. An example network 106 is the internet, though network 106 may, in some embodiments, encompass only private network paths or a combination of public and private network paths.

By way of specific example to illustrate aspects described herein, at check-out time the patient 102 presents a patient health care identification card to the provider's administrative staff member. The card provides insurance information used to facilitate downstream processes. The card may contain a barcode, magnetic strip, or similar medium that is swiped, scanned, or otherwise read and acquired by the provider 104. In some examples, the identification card is in digital form and the information is provided digitally (as a barcode, for instance) via an application on the patient's mobile device. Additionally or alternatively, the information may be acquired across communication path 103 that includes a digital communication path like a wireless (e.g. near-field identification, Bluetooth, Wi-Fi) connection.

In any case, a provider system 104 has the information for the provider system to engage with (e.g. log into) the portal 108 for an assessment of how much the patient will owe for the visit. Assume, for instance, that the provider bills-out to the payor health insurance company (Payor 1, 110a) the provided services at a negotiated rate of $200. Assume also that the patient's annual deductible is $1,000, after which the patient is responsible for a coinsurance of 20% of the negotiated rate, and that, in this case, the deductible has already been met by the patient for the current plan year (as indicated in data maintained at or available to Payor 1, 110a and/or portal 108). Accordingly, the patient 102 would be responsible for paying the coinsurance amount of $40 (20% of $200). Instead of this amount being determined at some later time and then billed to the patient 102 by the provider 104, facilities described herein (e.g. the portal 108) may determine and indicate this $40 patient responsibility at the time of patient checkout, thereby providing a real-time indication of patient responsibility so that the provider can immediately bill the patient and accept immediate payment.

In this example, the patient would be responsible for $40 and payor 1, 110a (as the health insurance company for this particular patient) would be responsible for the balance, $200−$40=$160. The provider 104 could receive a determination of this in real-time from the portal because the portal would have access to up-to-date information about patient claims, for instance the data maintained by the payor system. With this information at the time of the visit, the provider can bill the patient immediately, significantly improving the likelihood of collecting the patient's portion of the payment up-front and avoiding the cost of billing the patient later.

Thus, in some embodiments, patient-specific coverage data may be made available to the portal 108 by several payor health insurance companies 110. The portal 108 may periodically, aperiodically, and/or on-demand (for instance based on a request from a provider) acquire health care benefits data from the payors 110, use that to determine patient responsibility for specified service, and provide that to the provider when it requests a determination of patient responsibility. The provider 104 may tap into this data by logging into the portal 108 and providing patient identification information to access a patient responsibility determination and/or data for the patient 102 who uses one or more of payor health insurance companies 110 (assuming those companies participate in the system by making coverage data available to the portal 108).

In some examples, information from a payor 110 may not be immediately available on-demand when the provider desires a real-time determination of patient responsibility. In such cases, the portal 108 can obtain, track, and/or maintain sufficient claim information, such as prior claims, coverage amounts, deductible satisfaction, etc., to enable the portal itself to determine, or at least make an accurate prediction, of patient responsibility without immediately contacting payor system(s) 110 for this information every time a patient responsibility determination is needed. In some examples, the portal may synchronize from time-to-time with the payor system(s) to get/provide updated information on this and other health care coverage information to enable the portal to work semi-autonomously. This synchronization may occur aperiodically or periodically, for instance once a day. Additionally, as described above, an application may be provided for patient devices that enables the patient to track this information and request/obtain (from their own device or a remote system based on that tracked data) a determination of patient responsibility as described herein.

Payment services may be built-in to the system to facilitate patient and payor payments to the providers. Major card platforms (such as Visa®, a trademark of Visa Inc., Foster City, Calif., USA, and MasterCard®, a trademark of MasterCard Worldwide, Purchase, N.Y., USA) can be integrated into portal functionality to enable the patient to make a payment using any of a variety of payment methods. In one specific example, the patient's health insurance company can issue a payment-platform-branded financial product, such as BCBS Credit card, BCBS Debit card, or BCBS HSA against which patient payments can be made. In this regard, the payors provide an incentive to use, e.g., their branded forms of tender, such as a BCBS credit card. This practice in itself can drive revenue for the payors when their patients use payor-branded tender to satisfy the amounts for which the patients are responsible. The portal 108 can process the payment upon a request from the provider 104 and/or patient 102 and send a confirmation of payment to the provider 104 and/or patient 102 in real-time during patient check-out, for instance. Moreover, the portal 108 may be involved to process payments between the payors 110 and the provider 104.

Determining patient responsibility in real-time enables near-immediate billing to the patient, enabling the patient to pay the appropriate amount at the time (e.g. at some point immediately before, during, or after that visit) and point-of-treatment (POT). This may help the provider lower its bad-debt levels, i.e. money owed to the provider by the patients. In some examples, providers may incentivize immediate payment by offering discounts to the patients if they pay at the time and point of treatment. The discount may apply to the patient responsibility portion of the claim. Using the example above, the provider may offer a 10% discount to the patient who owes $40, thereby agreeing to settle with the patient for $36 if the patient pays at check-out. In some cases, this may be permitted only if the payor allows it. This near-immediate settlement facilitates improvement in provider revenues and cash flows, and avoidance of costly debt-recovery processes common when providers bill patients in the traditional manner, i.e. days or weeks after treatment. Reduction in patient bad-debts lowers provider overhead, which helps lower services costs that the providers may otherwise desire to pass on to the paying patients and/or payors. That is, since cost of services may be kept lower, payors may see a benefit through lower negotiated rates.

Some aspects described herein may be facilitated via patient mobile devices. For instance, the portal 108 may be able to accept and distribute information described herein through a variety of mobile devices/applications. As an example, patients may utilize a mobile application executing on a mobile device 102 to store and/or access (via a network connection) their personal insurance information and provide that information to a health services provider. The provider may obtain the information before, during, or after a patient visit and use it to engage the portal. In one example, the mobile application is used to provide information to the provider 104 and/or portal 108 that enables the provider 104 to identify the insurance information for that particular patient and/or authenticate with the portal 108 for secure access to privileged insurance information of the patient 102. The mobile device may provide authentication information, such as encrypted data, a secret key, unique scannable barcode, or the like, to the provider system 104 that then uses the provided authentication information to authenticate with the portal 108 and/or payor systems 110.

The portal may in turn disseminate payment information back to the patient's mobile device 102 and/or provider system 104. In some examples, this initiates the payment process for the consumer-patient on the patient's mobile device. An “app” (e.g. software application) running on the mobile device may enable the patient to customize his or her payment preferences via different tender types (e.g. credit, debit, HSA, etc.) and pay for the rendered services via the mobile app and/or device. In this regard, the mobile device may operate to gather and/or convey appropriate payment information to the portal 108, across communication path 111, and/or provider system 104 for processing of payments for services rendered to the patient. The mobile device may also store historical transaction data, track benefits and/or loyalty points, and/or use the benefits/points to purchase other items, per the preferences and allowances of the patient's insurance plan.

It is seen that a request for a patient responsibility determination may be passed to portal 108 in a variety of different ways. In some examples, the request is made by the provider system 104, which might provide an indication of the billing codes and other information about the services rendered. Additionally or alternatively, the provider system might provide data to the patient device 102 (e.g. through near-field, Bluetooth, or Wi-Fi connection 103, as examples) that then reaches out to portal 108 via communication path 111 (that may or may not pass across an internet connection, such as network 106). In some examples, the communication with the portal 108 is made by way of the patient device 102, where the provider system 104 wraps the claim information in a data construct and passes that to the client device 102, which then passes the information to the portal system 108. This may be done for security reasons, where the patient mobile device 102 is authenticated with the portal and the necessary claims data from the provider 104 is conveyed to the portal 108 by way of the patient device 102. The portal may determine patient responsibility as described herein and provide an indication of that patient responsibility back to the provider and/or mobile device.

Another example of facilitating settlement of patient responsibility is now provided with reference to FIG. 1B, which depicts another example environment to incorporate facilities for settlement of patient responsibility for health care service. FIG. 1B again includes patient 102, provider 104, portal 108, and payor 110. Initially, as indicated by step 1, provider 104 may request a determination of patient responsibility for proposed or rendered health care service. The request may include patient identification information, a provider tax identification number (TIN) and/or an indication of the health care service (for instance by way of identifiers such as International Classification of Diseases (ICD) codes, ICD 9/10 code(s), and/or Current Procedure Terminology (CPT) 4 codes). Based on the portal receiving this information, it can reach out to the payor system (step 2) to obtain health care benefits data. This may be done by presenting an 874 claim or through the use of another transaction type code, as examples (step 3). After processing the data, the payor can send back information related to the patient's eligibility and ultimately, their financial responsibility. Thus, at step 4, the portal provides to the provider system an indication of patient responsibility, e.g. patient out-of-pocket obligation, a reimbursement total indicating the total reimbursement to the provider, and/or an indication of payor adjudication (next-day settlement). In some examples, immediate adjudication may be possible, since if a payor knows how much is paid to a provider for a service in total, and it knows the patient part, then the payor may theoretically also know its part.

The patient responsibility can be communicated to the patient (step 5) and which point the patient may make a payment (step 6). To incentivize immediate payment, the patient may be offered a discount for paying at the time and point of treatment. The payment may be made directly to the provider (for instance in the form of cash, check, credit processed by the provider) and/or be made via the portal (step 7). The patient may authorize the portal to use a preconfigured form of tender, such as a payor-branded financial product. Finally, the portal may provide provider-specific reporting back to the payor (step 8). In this latter regard, and since a feature of models described herein is that they facilitate communication between payors and providers, a benefit for payors to enabling providers with the patient-specific information is that the payors may be able to show providers how much the system has helped providers to increase their collections and cash flow because of the data made available. This can help payors' positions when negotiating rates with providers, i.e. likely slowing rate increases, and helping the payors' profit lines.

Accordingly, aspects described herein include a central system accessible by a health care provider that provides real-time access to payor (example: health insurance company) health care benefits data related to patient health insurance coverage. This may enable a system, such as the central system to determine, in real-time (i.e. on-demand at, for instance, patient check-out) how much the patient will, or does, owe for given service(s) based on data accessed from the payor system(s). Thus, the central system can produce and/or provide relevant and real-time (up-to-date) data about patient financial coverage and benefit obligations, for instance out-of-pocket financial responsibility (amount that should be billed to the patient) under the patient's health care plan for the given service(s). The obtained health care benefits data may include any information that enables a system, such as the central system, to calculate the amount of money for which the patient is, or will ultimately be adjudicated to be, responsible. This can involve data about patient out-of-pocket amounts and/or amount covered by insurance for a specific service, policy coverages, co-pay amounts, deductible amounts, including amount satisfied to date, for any given patient of a participating health care company. It may take into consideration up-to-date numbers on financial coverage or benefits obligations, such as plan limits and deductible satisfaction, so as to provide an accurate, real-time indication of what the patient owes if the provider followed current methods of recovering money owed to the provider (i.e. bill the payor for adjudication, then bill any unsatisfied portion to the patient).

As described above, the system may also facilitate payment for health care services against financial products (credit card, debit card, health savings accounts, etc), for instance ones made available through, or used in conjunction with, the portal. A patient may be able to authorize payment to a provider via one or more of these products offered through the portal. The portal may log or maintain data about payments processed through one of these financial products, and may therefore determine how much providers are recovering for their services using the point-of-treatment payments. The portal can compare that to estimated bad-debt rates that are realized when patients are billed post-treatment (i.e. according to existing practices). This can provide an indication of how much money is being saved by the providers that use facilities described herein. That figure can be used to attract participation by other insurance companies, as they may want to be viewed as favorably by the provider community as other plans using the portal. Thus, a direct-to-payor electronic data interchange (EDI) platform is provided to facilitate patient payment processes and provide a reliable, retail-like customer experience. Aspects described herein enable, for instance, electronic interaction between provider and payor IT systems to facilitate real-time eligibility checking, real-time claim adjudication, and real-time remittance advice (RTA) transmission and electronic funds transfer (ETF), as examples.

Additionally, as indicated previously, an application, such as an application for installation on a patient mobile device, may be provided that facilitates the tracking of health care benefits data by the patient. In some examples, the application may receive indications from the patient or primary account holder of health care service and use that in conjunction with plan coverage information to perform a determination of patient responsibility. Additionally or alternatively, the application may be configured to reach out to a payor system, similar to processes performed by a portal as described herein, to obtain the health care benefits data. A patient may use the application to gauge prospectively patient responsibility before actually initiating the health care service. The application may enable the user to specify a health care service and determine/obtain an accurate indication of patient responsibility for the user-selected health service, should the service be performed. Since the application may have access to up-to-date health care benefits data, by way of patient input and/or access to the payor systems, the patient responsibility determination could account for this data and render an accurate indication of actual patient responsibility for the service.

Aspects described herein offer improvements over existing computer systems involved in health care claims resolution and billing of patients. Functioning of existing electronic systems that facilitate billing and reconciliation of claims and amounts owed, together with additional new system(s), such as a portal as described herein, provide improvements in computerized processing of patient claims and billing for health care services.

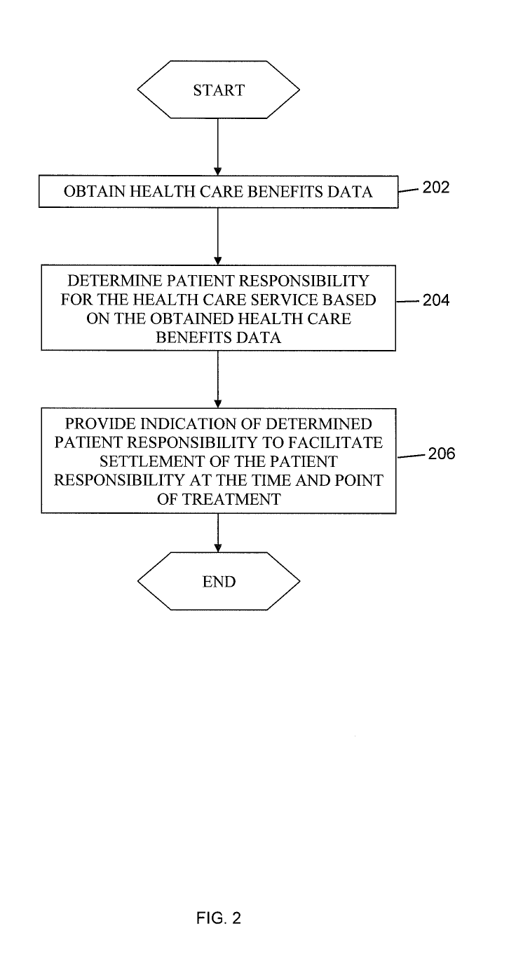

Accordingly, FIG. 2 depicts an example process to facilitate settlement of patient responsibility for health care service at a time and point of treatment, in accordance with aspects described herein. Aspects of FIG. 2 may be performed by one or more computer systems in a computing environment, such as an environment of FIG. 1A or FIG. 1B. In this regard, some or all aspects may be performed by a patient computer system, a provider computer system, a portal computer system, and/or a payor computer system. For instance, in some embodiments, processing of FIG. 2 is performed by a portal as described herein.

Referring to FIG. 2, health care benefits data is obtained (202). This may be obtained from a system of a payor of health care services, for instance. The health care benefits data may include information indicative of an extent to which financial coverage or benefit obligations have been met for the patient under an arrangement between the patient and the payor.

Based on an indication by a provider system that a determination of patient responsibility for the health care service is desired, the process may determine patient responsibility for the health care service based on the obtained health care benefits data (204). An indication of the determined patient responsibility may be provided to the provider system to facilitate settlement of the patient responsibility at the time and point of treatment (206). The time and point of treatment may include any time spanning from patient check-in at the provider to check-out at the provider for a patient visit at which at least some of the health care service is rendered to the patient.

In some embodiments, the information indicative of the extent to which financial coverage or benefit obligations have been met for the patient indicates a current extent to which one or more coverage deductibles or limits have been met for the patient for care provided to the patient, in which case determining the patient responsibility may account for the current extent to which the one or more coverage deductibles or limits have been met for the patient. Furthermore, in some examples the health care benefits data further includes an indication of a co-pay or co-insurance amount for which the patient is responsible, and the determination of the patient responsibility accounts for the co-pay or co-insurance amount for which the patient is responsible.

The patient responsibility may include a monetary amount dynamically dependent on the extent to which financial coverage or benefit obligations have been met for the patient up to the time of treatment. Additionally or alternatively, the patient responsibility may include a monetary amount deemed payable by the patient based on processing one or more claims directed to the health care service, for instance processing performed by the payor system based on the provider system forwarding an indication of the service to the payor system.

In some embodiments, the provider system might provide an indication to a mobile device of the patient that the determination of patient responsibility for the health care service is desired. Based on the mobile device receiving that indication, the portal may receive from the mobile device a request for a determination of patient responsibility, perform the determination of patient responsibility (e.g. 204 above) and then provide the indication of the determined patient responsibility to the provider system or to the mobile device of the patient for provision to the provider system.

Based on verification from the patient at the time and point of treatment that the determined patient responsibility is to be settled, e.g. paid, a payment by the patient may be processed to satisfy patient responsibility at the time and point of treatment. The processing of the payment may be based on receiving from a mobile device of the patient an indication of a credit account, debit account, or health spending account against which the payment is to be drawn. In some examples, such a payment product is provided through the payor, for instance as a payor-branded payment offering.

For authentication or other purposes, a provider system may obtain patient identification information from a mobile device of the patient, such as an application thereof, and the provider system may use the patient identification information to engage a remote system, such as a portal described herein, for the determination of the patient responsibility. In this case, the indication by the provider system that the determination of patient responsibility is desired may include at least some of that obtained patient identification information, which may be used to facilitate authentication of the provider system to engage with the remote system and receive the indication of the determined patient responsibility.

Additional methods and systems are provided, for instance those to facilitate obtaining an accurate and up-to-date determination of patient responsibility for prospective service to be provided to the patient. An example such method includes obtaining, from a system of a payor of health care services, health care benefits data including information indicative of an extent to which financial coverage or benefit obligations have been met for a patient under an arrangement between the patient and the payor, where the information indicative of the extent to which financial coverage or benefit obligations have been met for the patient indicates a current extent to which coverage deductible(s) or limits have been met for the patient for care provided to the patient. Then, an identification of health care service and a request for a determination of patient responsibility should the identified health care service be rendered by the patient may be received from the client. Based on the received identification of health care service and request for the determination, patient responsibility for the health care service is determined based on the obtained health care benefits data. This determination of patient responsibility accounts for the current extent to which the coverage deductible(s) or limits have been met for the patient, and where the patient responsibility includes a monetary amount dynamically dependent on the extent to which financial coverage or benefit obligations have been met for the patient up to the time of treatment. Finally, this indication of the determined patient responsibility is provided to the patient. In some examples, a mobile application is provided for the patient's mobile device and the application enables the patient to select/specify the health care service for which the patient is interested in obtaining an indication of patient responsibility, should the patient receive the indicated health care service. The selection of the service may be entered into the mobile application and sent to a portal or payor system, for instance. The indication of the determined patient responsibility may be provided back to the mobile application of the patient, thereby enabling a convenient and quick means for the patient to obtain an accurate indication of patient responsibility for contemplated health care service.

Those having ordinary skill in the art will recognize that aspects described herein may be embodied in system(s), method(s) and/or computer program product(s). In some embodiments, aspects described herein may be embodied entirely in hardware, entirely in software, or in a combination of software and hardware aspects that may all generally be referred to herein as a “system” and include circuit(s) and/or module(s).

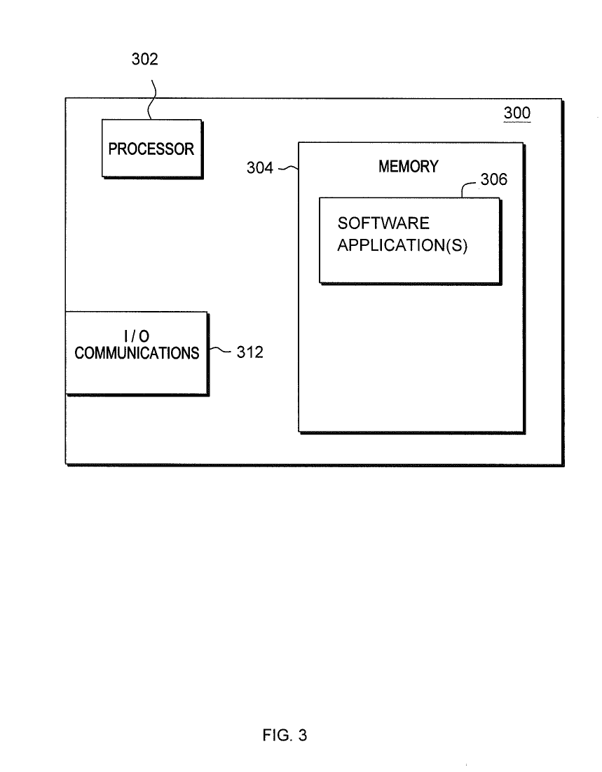

FIG. 3 depicts one example embodiment of a computer system to incorporate aspects described herein, specifically facilities for settlement of patient responsibility for rendered health care services. In this example, the facilities include software for execution to perform aspects described herein, such as aspects described above. The computer system of FIG. 3 presents an example patient system, provider system, portal system, or payor system, for instance.

Computer system 300 includes a processor 302 and memory 304. Processor 302 comprises any appropriate hardware component(s) capable of executing one or more instructions from memory 304. Memory 304 includes software application(s) 306 that execute to perform/provide facilities described herein.

Further, computer system 300 includes an input/output (I/O) communications interface component 312 for communicating data between computer system 300 and external devices, such as I/O and peripheral devices (mouse, keyboard, display devices) and network devices.

In some embodiments, aspects described herein may take the form of a computer program product embodied in one or more computer readable medium(s). The one or more computer readable medium(s) may have embodied thereon computer readable program code. Various computer readable medium(s) or combinations thereof may be utilized. For instance, the computer readable medium(s) may comprise a computer readable storage medium, examples of which include (but are not limited to) one or more electronic, magnetic, optical, or semiconductor systems, apparatuses, or devices, or any suitable combination of the foregoing. Example computer readable storage medium(s) include, for instance: an electrical connection having one or more wires, a portable computer diskette, a hard disk or mass-storage device, a random access memory (RAM), read-only memory (ROM), and/or erasable-programmable read-only memory such as EPROM or Flash memory, an optical fiber, a portable compact disc read-only memory (CD-ROM), an optical storage device, a magnetic storage device (including a tape device), or any suitable combination of the above. A computer readable storage medium is defined to comprise a tangible medium that can contain or store program code for use by or in connection with an instruction execution system, apparatus, or device, such as a processor. The program code stored in/on the computer readable medium therefore produces an article of manufacture (such as a “computer program product”) including program code.

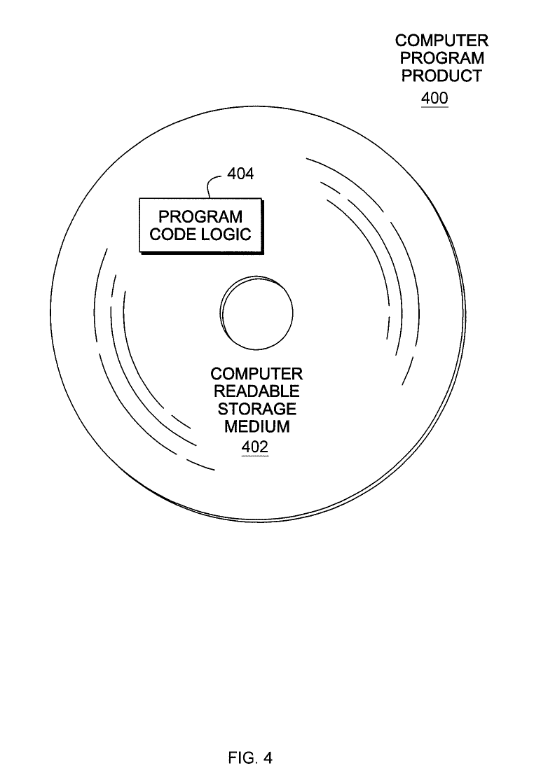

Referring now to FIG. 4, in one example, a computer program product 400 includes, for instance, one or more computer readable media 402 to store computer readable program code means or logic 404 thereon to provide and facilitate one or more aspects described herein.

Program code contained or stored in/on a computer readable medium can be obtained and executed by a computer system (computer, computer system, etc. including a component thereof) and/or other devices to cause the computer system, component thereof, and/or other device to behave/function in a particular manner. The program code can be transmitted using any appropriate medium, including (but not limited to) wireless, wireline, optical fiber, and/or radio-frequency. Program code for carrying out operations to perform, achieve, or facilitate aspects described herein may be written in one or more programming languages. In some embodiments, the programming language(s) include object-oriented and/or procedural programming languages such as C, C++, C#, Java, etc. Program code may execute entirely on the user's computer, entirely remote from the user's computer, or a combination of partly on the user's computer and partly on a remote computer. In some embodiments, a user's computer and a remote computer are in communication via a network such as a local area network (LAN) or a wide area network (WAN), and/or via an external computer (for example, through the Internet using an Internet Service Provider).

In one example, program code includes one or more program instructions obtained for execution by one or more processors. Computer program instructions may be provided to one or more processors of, e.g., one or more computer systems, to produce a machine, such that the program instructions, when executed by the one or more processors, perform, achieve, or facilitate aspects described herein, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

The flowcharts and block diagrams depicted and described with reference to the figures illustrate the architecture, functionality, and operation of possible embodiments of systems, methods and/or computer program products according to aspects described herein. These flowchart illustrations and/or block diagrams could, therefore, be of methods, apparatuses (systems), and/or computer program products according to aspects described herein.

In some embodiments, as noted above, each block in a flowchart or block diagram may represent a module, segment, or portion of code, which comprises one or more executable instructions for implementing the specified behaviors and/or logical functions of the block. Those having ordinary skill in the art will appreciate that behaviors/functions specified or performed by a block may occur in a different order than depicted and/or described, or may occur simultaneous to, or partially/wholly concurrent with, one or more other blocks. Two blocks shown in succession may, in fact, be executed substantially concurrently, or the blocks may sometimes be executed in the reverse order. Additionally, each block of the block diagrams and/or flowchart illustrations, and combinations of blocks in the block diagrams and/or flowchart illustrations, can be implemented wholly by special-purpose hardware-based systems, or in combination with computer instructions, that perform the behaviors/functions specified by a block or entire block diagram or flowchart.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method to facilitate settlement of patient responsibility for health care service at a time and point of treatment, the method comprising:
obtaining, from a system of a payor of health care services, health care benefits data comprising information indicative of an extent to which financial coverage or benefit obligations have been met for the patient under an arrangement between the patient and the payor;
based on an indication by a provider system that a determination of patient responsibility for the health care service is desired, determining patient responsibility for the health care service based on the obtained health care benefits data; and
providing an indication of the determined patient responsibility to the provider system to facilitate settlement of the patient responsibility at the time and point of treatment.

2. The method of claim 1, wherein the time and point of treatment comprises during patient check-in at the provider or check-out at the provider for a patient visit at which at least some of the health care service is rendered to the patient.

3. The method of claim 1, wherein the information indicative of the extent to which financial coverage or benefit obligations have been met for the patient indicates a current extent to which one or more coverage deductibles or limits have been met for the patient for care provided to the patient, and wherein the determining the patient responsibility accounts for the current extent to which the one or more coverage deductibles or limits have been met for the patient.

4. The method of claim 3, wherein the health care benefits data further comprises an indication of a co-pay or co-insurance amount for which the patient is responsible, and wherein the determining the patient responsibility accounts for the co-pay or co-insurance amount for which the patient is responsible.

5. The method of claim 3, wherein the patient responsibility comprises a monetary amount dynamically dependent on the extent to which financial coverage or benefit obligations have been met for the patient up to the time of treatment.

6. The method of claim 1, wherein the patient responsibility comprises a monetary amount deemed payable by the patient based on processing one or more claims directed to the health care service.

7. The method of claim 1, wherein an indication that the determination of patient responsibility for the health care service is desired is provided by the provider system to a mobile device of the patient and wherein, based on the mobile device receiving the indication, the method further comprises:
receiving from the mobile device a request for a determination of patient responsibility;
performing the determining patient responsibility; and
providing the indication of the determined patient responsibility to the provider system or to the mobile device of the patient for provision to the provider system.

8. The method of claim 1, wherein based on a verification from the patient at the time and point of treatment that the patient responsibility is to be settled, the method further comprises processing a payment by the patient to satisfy patient responsibility at the time and point of treatment.

9. The method of claim 8, wherein the processing the payment is based on receiving from a mobile device of the patient an indication of a credit account, debit account, or health spending account against which the payment is to be drawn.

10. The method of claim 1, further comprising:
obtaining patient identification information from a mobile device of the patient; and
using, by the provider system, the patient identification information obtained from the mobile device to engage a remote system for the determination of the patient responsibility, wherein the indication by the provider system that the determination of patient responsibility is desired comprises at least some of the patient identification information obtained from the mobile device to facilitate authentication of the provider system to engage with the remote system and receive the indication of the determined patient responsibility.

11. A system to facilitate settlement of patient responsibility for health care service at a time and point of treatment, the system comprising:
a memory; and
a processor in communication with the memory, wherein the system is configured to perform:
obtaining, from a system of a payor of health care services, health care benefits data comprising information indicative of an extent to which financial coverage or benefit obligations have been met for the patient under an arrangement between the patient and the payor;
based on an indication by a provider system that a determination of patient responsibility for the health care service is desired, determining patient responsibility for the health care service based on the obtained health care benefits data; and
providing an indication of the determined patient responsibility to the provider system to facilitate settlement of the patient responsibility at the time and point of treatment.

12. The system of claim 11, wherein the time and point of treatment comprises during patient check-in at the provider or check-out at the provider for a patient visit at which at least some of the health care service is rendered to the patient.

13. The system of claim 11, wherein the information indicative of the extent to which financial coverage or benefit obligations have been met for the patient indicates a current extent to which one or more coverage deductibles or limits have been met for the patient for care provided to the patient, and wherein the determining the patient responsibility accounts for the current extent to which the one or more coverage deductibles or limits have been met for the patient.

14. The system of claim 13, wherein the health care benefits data further comprises an indication of a co-pay or co-insurance amount for which the patient is responsible, and wherein the determining the patient responsibility accounts for the co-pay or co-insurance amount for which the patient is responsible.

15. The system of claim 13, wherein the patient responsibility comprises a monetary amount dynamically dependent on the extent to which financial coverage or benefit obligations have been met for the patient up to the time of treatment.

16. The system of claim 11, wherein the patient responsibility comprises a monetary amount deemed payable by the patient based on processing one or more claims directed to the health care service.

17. The system of claim 1, wherein an indication that the determination of patient responsibility for the health care service is desired is provided by the provider system to a mobile device of the patient and wherein the system is further configured to perform, based on the mobile device receiving the indication:
receiving from the mobile device a request for a determination of patient responsibility;
performing the determining patient responsibility; and
providing the indication of the determined patient responsibility to the provider system or to the mobile device of the patient for provision to the provider system

18. The system of claim 11, wherein the system is further configured to perform, based on a verification from the patient at the time and point of treatment that the patient responsibility is to be settled: processing a payment by the patient to satisfy patient responsibility at the time and point of treatment, wherein the processing the payment is based on receiving from a mobile device of the patient an indication of a credit account, debit account, or health spending account against which the payment is to be drawn.

19. The system of claim 11, wherein the indication by the provider system that the determination of patient responsibility is desired comprises at least some patient identification information obtained by the provider system from the mobile device to facilitate authentication of the provider system to engage with the system and receive the indication of the determined patient responsibility.

20. A method comprising:
obtaining, from a system of a payor of health care services, health care benefits data comprising information indicative of an extent to which financial coverage or benefit obligations have been met for a patient under an arrangement between the patient and the payor, wherein the information indicative of the extent to which financial coverage or benefit obligations have been met for the patient indicates a current extent to which one or more coverage deductibles or limits have been met for the patient for care provided to the patient;
receiving, from the patient, an identification of health care service and a request for a determination of patient responsibility should the identified health care service be rendered by the patient;
based on the received identification of health care service and request for the determination, determining patient responsibility for the health care service based on the obtained health care benefits data, wherein the determining the patient responsibility accounts for the current extent to which the one or more coverage deductibles or limits have been met for the patient, and wherein the patient responsibility comprises a monetary amount dynamically dependent on the extent to which financial coverage or benefit obligations have been met for the patient up to the time of treatment; and
providing an indication of the determined patient responsibility to the patient.
